(19) United States
(12) Patent Application Publication
(10) Pub. No.: US 2026/0269623 A1
(43) Pub. Date: Sep. 10, 2026

(54) CONTROLLABLE POWER SUPPLY UNIT FOR RECREATIONAL VEHICLE

(71) Applicant: Madison Renewables, LLC, Echo, OR (US)

(72) Inventor: Kent R. Madison, Echo, OR (US)

(73) Assignee: Madison Renewables, LLC, Echo, OR (US)

(21) Appl. No.: 19/532,929

(22) Filed: Feb. 6, 2026

Related U.S. Application Data
(60) Provisional application No. 63/769,642, filed on Mar. 10, 2025.

(51) Int. Cl. H02J 3/38; G06Q 50/06; H02J 3/28; H02J 13/10; H02J 13/12; H02J 13/13; H02J 13/34; H02J 105/42

(52) U.S. Cl. CPC H02J 3/38; G06Q 50/06; H02J 3/28; H02J 13/10; H02J 13/12; H02J 13/1335; H02J 13/34; H02J 2105/42

(57) ABSTRACT

A controllable power supply unit for a recreational vehicle (RV) manages when utility power from a power pedestal is delivered to the RV. The unit includes a power input configured to couple to the pedestal, a power outlet configured to couple to the RV, and a plurality of electrically controlled contacts (e.g., a contactor) between the input and outlet. A programmable controller operates the contacts based on user-selected criteria, including a shutoff time at which the contacts open to interrupt pedestal power and an energize time at which the contacts close to restore pedestal power, thereby enabling temporal load shifting. When pedestal power is interrupted, one or more RV loads can be supplied by an onboard battery.

### CROSS REFERENCE TO RELATED APPLICATION

This application claims the benefit of U.S. Provisional Patent Application No. 63/769,642, filed Mar. 10, 2025, which is incorporated herein by reference.

### FIELD

The present disclosure concerns examples of controllable power supply units for supplying electrical power to recreational vehicles.

### BACKGROUND

Recreational vehicle camping is a popular pastime that allows people to bring the comforts of home with them while they camp. Recreational vehicles can include a variety of appliances and other electrical loads, for example, air conditioning units, heaters, electrical cooking appliances, and/or entertainment devices. Many recreational vehicle sites offer a power pedestal which can be electrically coupled to a recreational vehicle and supply power to the recreational vehicle and to a battery located within the recreational vehicle. When a power pedestal is not available or when it is desired, the recreational vehicle can be disconnected from the power pedestal and the recreational vehicle battery can be used to power at least some of the recreational vehicle electrical loads.

Peak power pricing has become popular with utility companies and refers to a system where electricity costs more during periods of high demand. Most commonly, peak pricing is implemented through a “time-of-use” billing plan, where different electricity rates apply depending on the time of day. Periods of high demand are designated as “peak hours,” and higher rates during these hours encourage consumers to shift their energy usage to cheaper “off-peak” times when demand is lower. This can help utility companies manage their power grid more efficiently.

### SUMMARY

Described herein are controllable power supply units for recreational vehicles and the like, and methods of use. Recreational vehicles can include towable trailers and motorized vehicles such as motorcoaches that include living quarters for overnight accommodation. The disclosed controllable power supply units can for example provide temporal load-shifting of electrical loads. The controllable power supply units can also allow monetary savings on electricity. As such, the controllable power supply units and methods of use disclosed herein can, among other things, overcome one or more of the deficiencies of typical recreational vehicle electrical power supplies.

In some examples, a controllable power supply unit for a recreational vehicle comprises: a power input connection configured to receive electrical power from a power pedestal; a power outlet configured to supply power to a recreational vehicle; a programmable controller; and a plurality of electrical contacts disposed between and in electrical contact with the power input connection and the power outlet, each of the plurality of electrical contacts comprising an open position and a closed position, wherein the programmable controller is configured to control a position of the plurality of electrical contacts based on one or more preselected criteria.

In some examples, the controllable power supply unit comprising one or more circuit breakers disposed between, and in electrical contact with, the power input connection and the power outlet. In some examples, the power input connection comprises a male plug configured to connect to a power pedestal and receive a 50-amp power supply. In some examples, the power outlet is a 50-amp receptacle configured to receive a 50-amp plug. In some examples, the controllable power supply unit comprises a user interface configured to allow the user to input the preselected criteria into the programmable controller. In some examples, the preselected criteria comprises a shutoff time and an energize time, and the programmable controller is configured to position the plurality of electrical contacts in the open position at the shutoff time and to position the plurality of electrical contacts in the closed position at the energize time. In some examples, the controllable power supply unit comprises a transformer electrically coupled to the power input connection and configured to step down power from the power input connection to power the programmable controller. In some examples, a recreational vehicle comprises the power supply unit. In some examples, the recreational vehicle comprises a battery in electrical contact with the controllable power supply unit.

In some examples, a recreational vehicle power system, comprises: a battery; a controllable power supply unit electrically coupled to the battery, the controllable power supply unit comprises: a power input cable configured to be electrically coupled to a power pedestal; a power outlet configured to be electrically coupled to the battery; a programmable controller; and a plurality of electrical contacts disposed between and in electrical contact with the power input cable and the power outlet, each of the plurality of electrical contacts comprising an open position and a closed position; wherein the programmable controller is configured to control a position of the plurality of electrical contacts based on one or more preselected criteria and wherein when the plurality of electrical contacts are in the closed position, electrical power is supplied to a recreational vehicle and the battery from the power pedestal and wherein when the plurality of electrical contacts are in the open position, electrical power is supplied to the recreational vehicle by the battery.

In some examples, the recreational vehicle power system comprises a user interface configured to allow the user to input the preselected criteria into the programmable controller. In some examples, the preselected criteria comprise a shutoff time and an energize time, and the programmable controller is configured to position the plurality of electrical contacts in the open position at the shutoff time and to position the plurality of electrical contacts in the closed position at the energize time. In some examples, the programmable controller is configured to monitor a state of charge of the battery and to position the plurality of electrical contacts in the closed position when the state of charge falls below a predetermined setpoint. In some examples, the power input cable comprises a male plug configured to connect to a power pedestal and receive 50-amp electrical power. In some examples, the recreational vehicle power system comprises one or more sensors configured to monitor electrical power supplied to the recreational vehicle power system. In some examples, the recreational vehicle power system comprises one or more circuit breakers disposed between, and in electrical contact with, the power input cable and the power outlet. In some examples, a transformer is electrically coupled to the power input cable and configured to step down voltage from the power input cable to power the programmable controller. In some examples, a recreational vehicle comprises the recreational vehicle power system.

In some examples, a method of supplying electrical power to a recreational vehicle with a controllable power supply unit, comprises: receiving instructions from a user via a user interface device, wherein the instructions comprise an energize time and a shutoff time; when the energize time is reached, moving a plurality of contacts of the controllable power supply unit to a closed position to supply electrical power to the recreational vehicle; and when the shutoff time is reached, moving the plurality of contacts to an open position to interrupt electrical power to the recreational vehicle. In some examples, the method comprises monitoring electrical power supplied to a recreational vehicle power system using one or more sensors.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 depicts a recreational vehicle which is electrically coupled to a power pedestal via a controllable power supply unit.

FIG. 2 depicts a frontal view of the controllable power supply unit according to one example.

FIG. 3 depicts a power outlet of the controllable power supply unit of FIG. 2.

FIG. 4 depicts the inside portion of a front panel of the controllable power supply unit of FIG. 2.

FIG. 5 depicts the components inside the enclosure box of the controllable power supply unit of FIG. 2 with a front panel open.

FIG. 6 depicts the controllable power supply unit of FIG. 2 electrically coupled to a power pedestal.

FIGS. 7A-7D depict schematic diagrams of components of the controllable power supply unit.

FIGS. 8A-8B depict graphs showing power usage without the controllable power supply unit and with the controllable power supply unit.

FIG. 9 depicts a representative example of a computing environment in which the functionality of the controllable power supply unit examples described herein can be implemented.

FIG. 10 depicts a recreational vehicle with an onboard controllable power supply unit which is electrically coupled to a power pedestal.

### DETAILED DESCRIPTION

Vehicles such as recreational vehicles (also referred to as RVs) and/or watercraft (e.g. boats, yachts, ships, etc.) can include a variety of appliances and other electrical loads, for example, air conditioning units, heaters, electrical cooking appliances, and/or entertainment devices. Recreational vehicles can be motorized (e.g., motor coaches or motorhomes) or non-motorized (e.g., towable trailers). Many recreational vehicle sites and/or vessel moorings may offer a utility station such as a power pedestal, which can supply electrical power for operating electrical loads on the vehicle and for charging a vehicle battery. In some examples, when a power pedestal is not available or when desirable, the vehicle can be disconnected from the power pedestal and the vehicle battery can be used to power at least some of the vehicle electrical loads.

Utility companies are increasingly implementing peak power pricing programs under which electricity costs more during periods of high demand. Most commonly, peak pricing is implemented through “time-of-use” pricing, where different electricity rates apply depending on the time of day the electricity is used. Periods of high demand are designated as “peak hours,” (also referred to as “mid-peak”) and higher rates during these hours encourage consumers to shift their energy usage to cheaper “off-peak” times when demand and electricity prices are lower. In some examples, the time of use can be further broken out into more than two categories, with different prices for each category.

Described herein are examples of controllable power supply units which allow users to preselect a criteria for automatically disconnecting their recreational vehicle from the power pedestal. Some or all of the electrical loads of the recreational vehicle can then be supplied with electricity from a battery, such as the RV's onboard battery. This can allow a user to avoid using electricity from the grid during “peak hours” which can save the user money. In some examples, the user can shift their electrical load to “off-peak” times by charging the recreational vehicle battery during “off-peak” hours then using the power stored in the battery during “peak hours.” Although the following examples pertain to land-based recreational vehicles, it should be understood that the systems and methods described herein can also be adapted for use with watercraft.

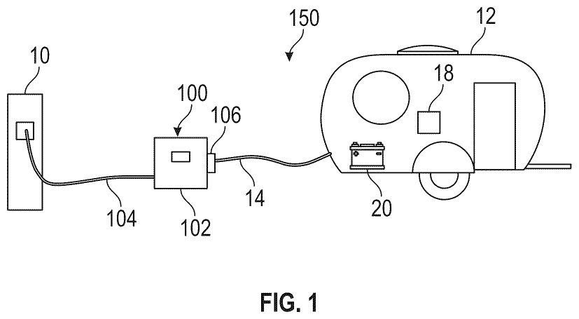

FIG. 1 depicts a recreational vehicle 12 and a recreational vehicle power system 150 including a controllable power supply unit 100 and a battery 20 of the recreational vehicle 12. The battery 20 and the electrical power system 150 of the recreational vehicle 12 can be electrically coupled to a power pedestal 10 via the controllable power supply unit 100. The controllable power supply unit 100 can be configured to selectively provide electrical power to the recreational vehicle 12 from the power pedestal 10 based on a variety of user-selectable criteria such as pre-selected on and off times, as further described below. As depicted, the controllable power supply unit 100 can comprise a main enclosure 102, a power input connection 104, and a power outlet 106. In the illustrated example, the power input connection 104 is configured as an electrical power input cable interconnecting the power pedestal 10 and the controllable power supply unit 100. In some examples, the power input connection 104 can comprise a male plug configured to connect to the power pedestal 10. The power input connection 104 can be configured to draw electrical power from the power pedestal 10 (e.g., up to 50 amps at up to 240 volts). The power outlet 106 can be configured to supply electrical power to a recreational vehicle 12. In some examples, the power outlet 106 can be a 50-amp receptacle configured to receive a 50-amp male plug of the power cable 14 to supply electrical power to the recreational vehicle 12.

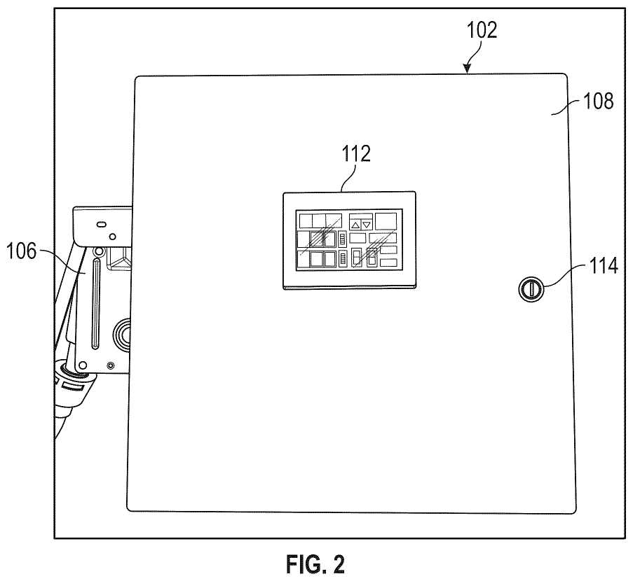

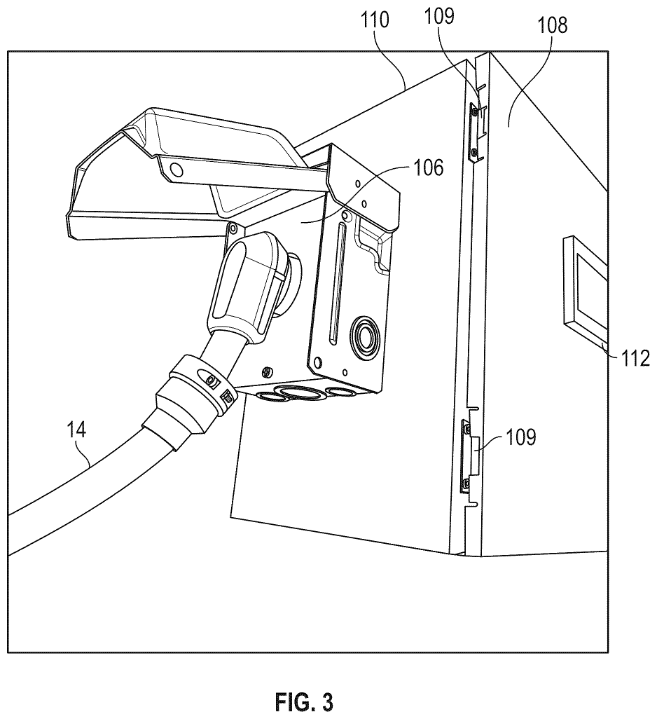

FIGS. 2-3 depict the outside of the main enclosure 102 of the controllable power supply unit 100 according to one example. The main enclosure 102 can protect the components of the controllable power supply unit 100 from the outside environment, for example from precipitation. In some examples, the main enclosure 102 comprises a front panel 108 and an enclosure box 110. The front panel 108 can house the user interface device 112. The user interface device 112 can be configured to receive input instructions from a user and can be in communication with a programmable controller 120.

In some examples, the user interface device allows the user to input one or more preselected criteria into the programmable controller 120. The programmable controller 120 can control a position of a plurality of electrical contacts based on the one or more preselected criteria. In some examples, user interface device 112 can be used to set a shutoff time and an energize time. In some examples, the user interface device 112 can be used to manually control the controllable power supply unit 100, for example with an on/off switch. In some examples, the user interface device 112 can be used to manually set the time zone. In some examples, the user interface device 112 can be used to input other criteria to the programmable controller 120. In some examples, the user interface device can comprise a touchscreen, one or more buttons, one or more dials, combinations thereof, or another mechanism for user input. In some examples, the user interface device 112 can comprise a display, for example LED lights, a screen and/or a touch screen, which can output data from the programmable controller 120 to be viewed by the user. In some examples, the controllable power supply unit 100 can include wireless Wi-Fi and/or Bluetooth functionality which can allow the user to remotely input instructions to the controllable power supply unit 100 from another device (e.g., a smartphone).

The front panel can further comprise a locking mechanism 114 which can secure the front panel 108 to the enclosure box 110. The main enclosure 102 can comprise metal, for example aluminum, galvanized steel, cast iron, or stainless steel. In some examples, the main enclosure 102 can be constructed of a polymer, such as PVC or polycarbonate. In some examples, the main enclosure 102 can comprise fiberglass.

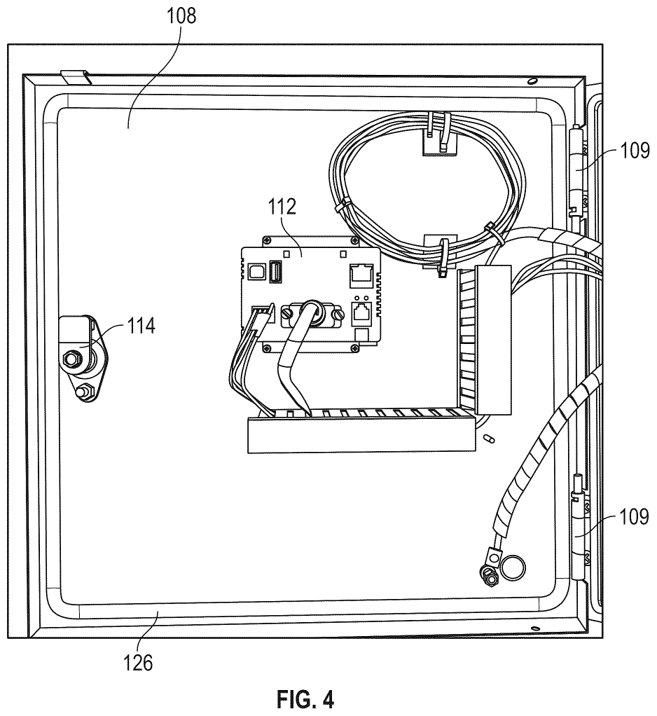

In some examples, the front panel 108 can be coupled to the enclosure box 110 by hinges 109 and can move between an open position and a closed position to access the interior of the main enclosure 102. FIG. 4 depicts the inside of the front panel 108. As mentioned above, the front panel 108 can house the user interface device 112 such that the inside of the front panel 108 comprises the back portion of the user interface device 112 which can be communicatively coupled with the controller 120 via one or more power and/or data cables. The locking mechanism 114 and the hinges 109 are also depicted. In some examples, a seal 126 can extend along the perimeter of the inside of the front panel 108 and can comprise a synthetic rubber. In some examples, the seal 126 can comprise another material such as rubber, plastic, or another similar material.

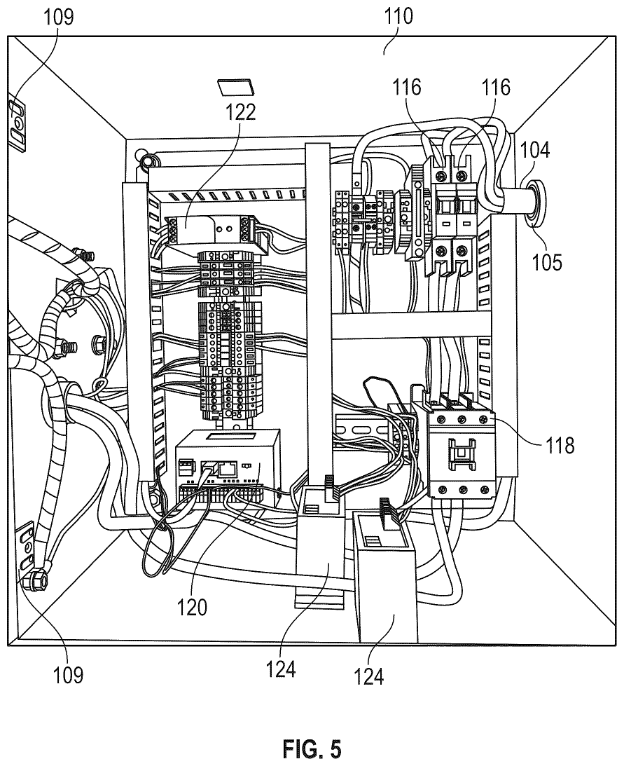

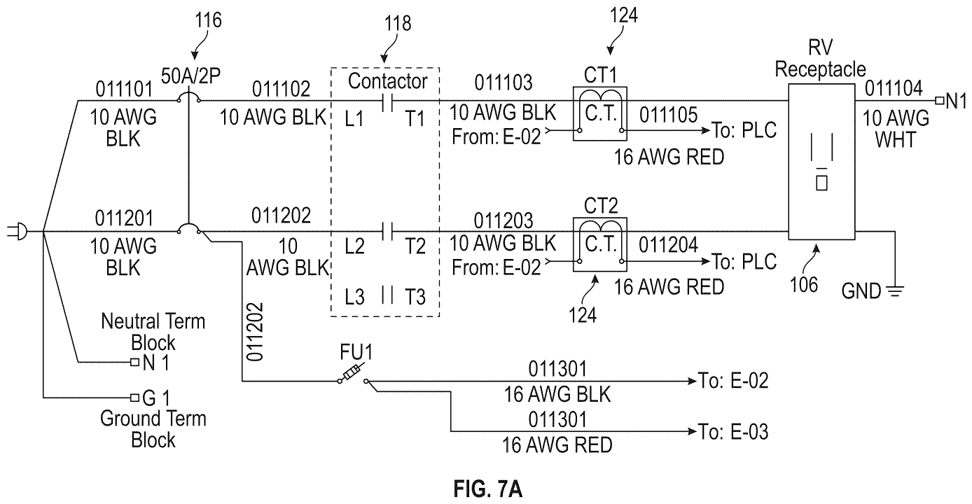

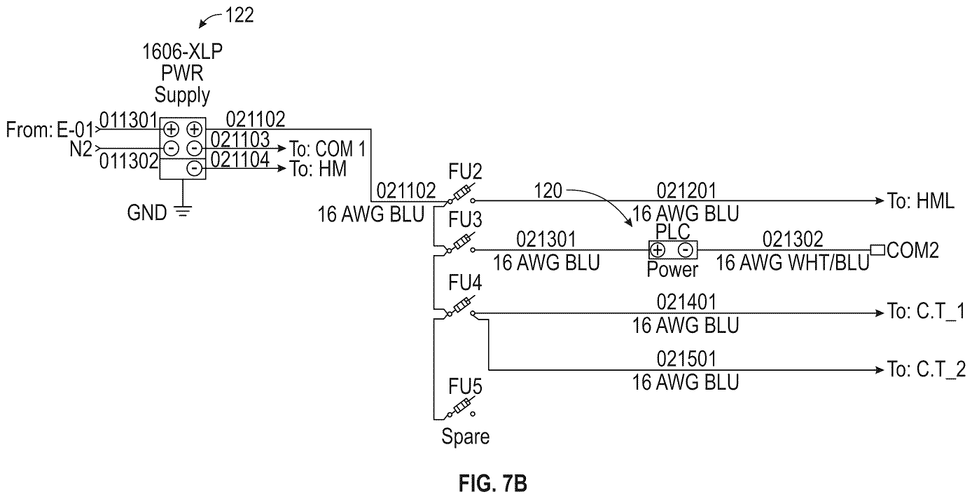

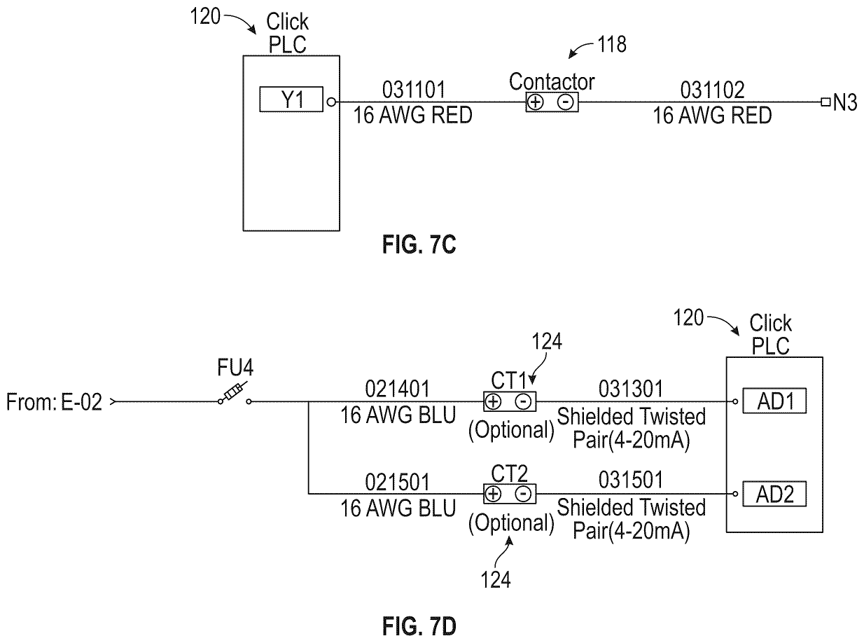

FIG. 5 depicts the inside of the enclosure box 110. As depicted, the power input connection 104 can enter the enclosure box 110 through a first aperture 105. When configured for use in the United States and Canada, the power input connection 104 can supply up to 240 volts of electrical power and the total amperage available can be up to 50 amps. The power input can be split into two 120-volt circuits, each with a separate “hot” or current-carrying wire. The enclosure box 110 can comprise one or more circuit breakers 116, one or more contactors 118, the programmable controller 120 and/or a transformer 122. In some examples, the enclosure box 110 can comprise one or more circuit measurement sensors 124 which can be configured to monitor electrical power supplied to the recreational vehicle power system. For example, the sensors 124 can measure current, voltage, resistance, etc., of the electrical circuit connecting the recreational vehicle and the controllable power supply unit 100. These components can be electrically coupled to one another as depicted in the schematic circuit diagrams of FIGS. 7A-7D.

The one or more circuit breakers 116 can be used to protect the components of the controllable power supply unit 100. In some examples, the circuit breakers 116 can automatically turn off power to an overloaded electrical circuit which can prevent damage to the controllable power box, such as overheating and/or fires. In some examples, the breakers can be 50 Amp, 2 pole circuit breakers. In some examples, the breakers can be selected based on the electrical properties of the recreational vehicle 12 and the power pedestal 10.

The contactor 118 can be used to make or break an electrical connection between the load, for example the recreational vehicle 12, and a source of electrical power, for example the pedestal 10. The contactor 118 can comprise a plurality of electrical contacts which can be in an open position or closed position as a result of a control signal sent by the programmable controller 120. When the plurality of contacts are in the closed position, power is supplied to a recreational vehicle and/or the vehicle's onboard battery from the power pedestal 10 via the controllable power supply unit. When the contacts of the contactor 118 are in the open position, power from the power pedestal 10 is interrupted. In some examples, with contacts of the plurality of contacts in the open position, power can be supplied to the recreational vehicle 12 by the battery. In some examples, the contactor 118 can be a 50A, 3 normally open (N.O.) power poles, 120 VAC (60 Hz)/110 VAC (50 Hz) coil voltage contactor. In some examples, the contactor can be a Fuji Electric SC-E2S series IEC contactor. In some examples, the contactor can be selected based on the electrical properties of the recreational vehicle 12 and the power pedestal 10. In some examples, the contactor can be a non-mechanical contactor, for example a solid-state contactor. While these non-mechanical contactors do not have literal open and/or closed positions, a person of skill in the art with the benefit of this disclosure would understand a non-mechanical contactor could be used as contactor 118 and would have configurations which could be referred to as an “open position” (i.e., in which the flow of electricity is interrupted) and a “closed position” (i.e., in which an electrical circuit is completed).

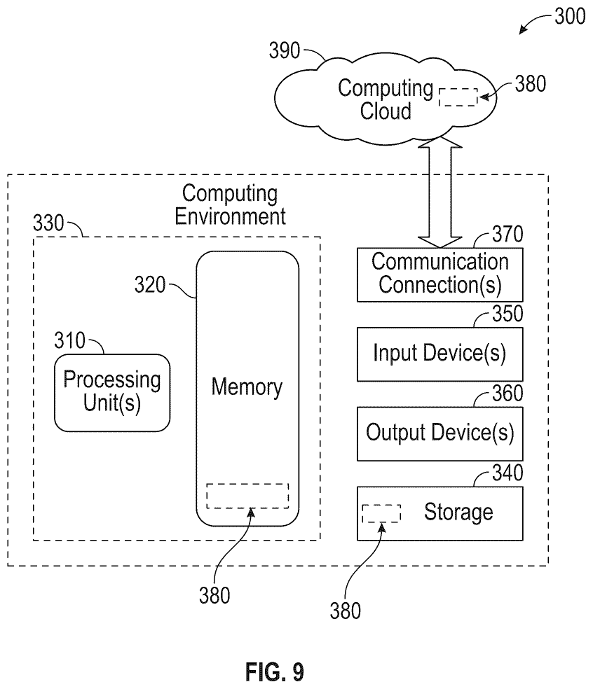

The programmable controller 120 can be used to receive and process data and output control signals to other components within the controllable power supply unit 100. The programmable controller 120 can be configured to read various inputs, (e.g. inputs from sensors and/or user inputs), process the data, and output a control signal. The programmable controller 120 can be configured to control a position of the plurality of electrical contacts of the contactor 118 based on one or more preselected criteria. In some examples, the controller can be a programmable logic controller (PLC) which can manage electromechanical processes based on preselected criteria. In some examples, the preselected criteria can be entered by a user via the user interface device 112. In some examples, the preselected criteria can comprise the shutoff time and the energize time, and the controller 120 can send a signal to the contactor 118 when the shutoff time is reached to move the plurality of contacts to the open position. In some examples, when the energize time is reached the controller can send a signal to the contactor 118 to move the plurality of contacts to the closed position. In some examples, the programmable controller 120 can be configured to monitor a state of charge of the battery 20 and to position the plurality of contacts of the contactor 118 to the closed position when the state of charge falls below a predetermined setpoint. An example of a computing environment for a controller 120 is depicted in FIG. 9.

The transformer 122 can be configured to receive a power input at a higher voltage and step it down to a power output voltage usable by electronics in the controllable power supply unit 100. In some examples, the transformer 122 can provide power to the user interface device 112, the controller 120 and/or the one or more sensors 124. In some examples, the transformer can be configured to have an input of the 120 VAC power from the power input connection 104 and can output 24 VDC power.

In some examples, the controllable power supply unit 100 can comprise one or more sensors 124 which can measure the power flow in cables electrically coupled to the power outlet 106. The sensors 124 can send signals to the programmable controller 120 to monitor the electricity output.

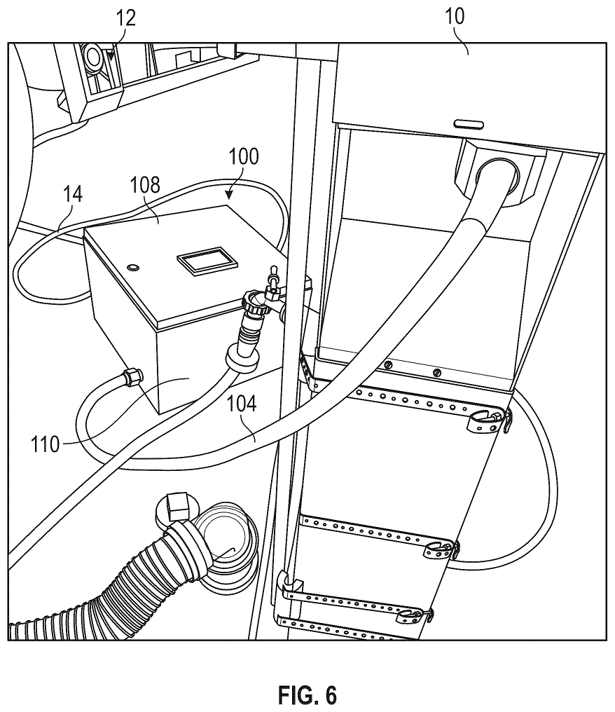

FIG. 6 depicts a power pedestal 10 electrically coupled to a controllable power supply unit 100, which is electrically coupled to a recreational vehicle 12. As depicted, the controllable power supply unit 100 can comprise a main enclosure 102, and a power input connection 104. The power input connection 104 can be configured to receive electrical power from the power pedestal 10. The power cable 14 which can electrically couple the recreational vehicle 12 to the controllable power supply unit 100.

FIGS. 7A-7D depict schematic diagrams of portions of the controllable power supply unit 100 including components as described above. For example, the circuit breakers 116, the contactor 118, the programmable controller 120, the transformer 122, the sensors 124, and the power outlet 106.

In use, the controllable power supply unit 100 as described above can be connected to a power pedestal 10 using the power input connection 104. The power cable 14 can extend from the recreational vehicle 12 and can be electrically coupled to the power outlet 106 on the controllable power supply unit 100. A user can input instructions into the controllable power supply unit 100 via the user interface device 112. For example, the user can input a shutoff time and an energize time. The controllable power supply unit 100 can open the contacts of the contactor 118 and interrupt electrical power from the power pedestal 10 to the recreational vehicle 12 when the preselected criteria is met, for example, at a predetermined shutoff time. When the contacts in the contactor are open, electrical loads on the recreational vehicle 12 may be powered by the battery 20. When the energize time is reached, the controllable power supply unit 100 can close the contacts of the contactor 118 and restore power from the power pedestal 10 to the recreational vehicle 12. The battery 20 can be charged while the controllable power supply unit 100 is supplying power from the power pedestal 10 to the recreational vehicle 12.

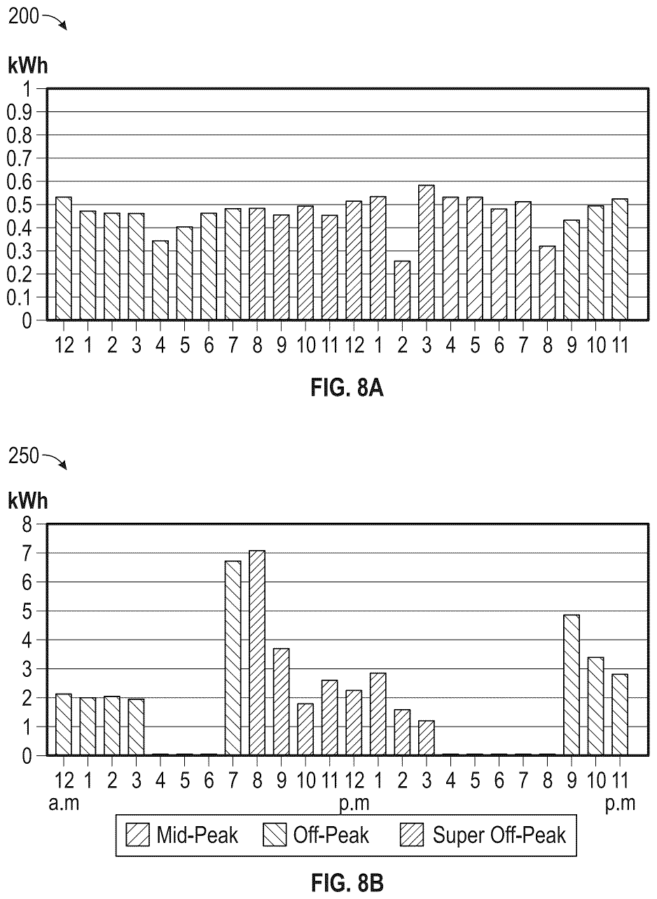

FIGS. 8A-8B depict electrical power usage charts where the x-axis represents a time of day, and the y-axis represents electrical usage in kilowatt-hours (kWh). FIG. 8A depicts a graph 200 showing power usage for a recreational vehicle with no controllable power supply unit 100. There is electricity used during the peak hours of 4:00 pm to 8:00 pm. FIG. 8B depicts graph 250 showing power usage for a recreational vehicle with the controllable power supply unit 100 installed. There is no electrical use during the peak hours of 4:00 pm to 8:00 pm. In this way, the user is able to avoid using electricity during the peak hours and save money.

FIG. 9 illustrates a generalized example of a computing environment 300 in which software and control algorithms for the controllable power supply unit examples described herein can be implemented. For example, software and/or hardware for implementing the various control systems and methods for controlling the timing of electrical power delivery to an RV described herein can be configured similarly to the computing environment 300, and can be a local computing system integrated as part of the controllable power supply unit or can be a remote computing system as described herein.

The computing environment 300 is not intended to suggest any limitation as to scope of use or functionality of the technology, as the technology may be implemented in diverse general-purpose or special-purpose computing environments. For example, the disclosed technology may be implemented with other computer system configurations, including programmable automation controllers, programmable logic controllers, application-specific integrated circuits (ASICs), field-programmable gate arrays (FPGAs), hand held devices, multi-processor systems, programmable consumer electronics, network PCs, minicomputers, and the like. The disclosed control methodology may also be practiced in distributed computing environments where tasks are performed by remote processing devices that are linked through a communications network. In a distributed computing environment, program modules may be located in both local and remote memory storage devices.

With reference to FIG. 9, the computing environment 300 includes at least one processing unit 310 and memory 320. In FIG. 9, this most basic configuration of computing environment 330 is included within a dashed line. The processing unit 310 executes computer-executable instructions and may be a real or a virtual processor. In a multi-processing system, multiple processing units execute computer-executable instructions to increase processing power and as such, multiple processors can be running simultaneously. The memory 320 may be volatile memory (e.g., registers, cache, RAM), non-volatile memory (e.g., ROM, EEPROM, flash memory, etc.), or some combination of the two. The memory 320 stores software 380 that can, for example, implement the technologies described herein. A computing environment may have additional features. For example, the computing environment 300 includes storage 340, one or more input devices 350, one or more output devices 360, and one or more communication connections 370. An interconnection mechanism (not shown) such as a bus, a controller, or a network, interconnects the components of the computing environment 300. Typically, operating system software (not shown) provides an operating environment for other software executing in the computing environment 300, and coordinates activities of the components of the computing environment 300.

The storage 340 may be removable or non-removable, and includes non-volatile solid state memory, magnetic disks, or any other medium which can be used to store information and that can be accessed within the computing environment 300. The storage 340 stores instructions for the software 380, plugin data, and messages, which can be used to implement technologies described herein.

The input device(s) 350 may be, for example, a touch input device such as a keyboard, keypad, mouse, touch screen display, pen, or trackball, a voice input device, a scanning device, circuit measurement sensor, or another device, that provides input to the computing environment 300. The output device(s) 360 may be a wired or wireless signal transmitter, a display, or another device that provides output from the computing environment 300.

The communication connection(s) 370 enable communication over a communication medium (e.g., a connecting network) to devices or computing entities. The communication medium conveys information such as control signals, computer-executable instructions, sensor inputs or outputs, or other data in a modulated data signal. The communication connection(s) 370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controlled devices.

Some embodiments of the disclosed methods can be performed using computer-executable instructions implementing all or a portion of the disclosed technology in a computing cloud 390 or other remote computing system. For example, the disclosed methods can be executed on processing units 310 located in the computing environment 330, or the disclosed methods can be executed on servers located in the computing cloud 390.

Computer-readable media are any available media that can be accessed within a computing environment 300. By way of example, and not limitation, with the computing environment 300, computer-readable media include memory 320 and/or storage 340. As should be readily understood, the term computer-readable storage media includes the media for data storage such as memory 320 and storage 340, and not transmission media such as modulated data signals.

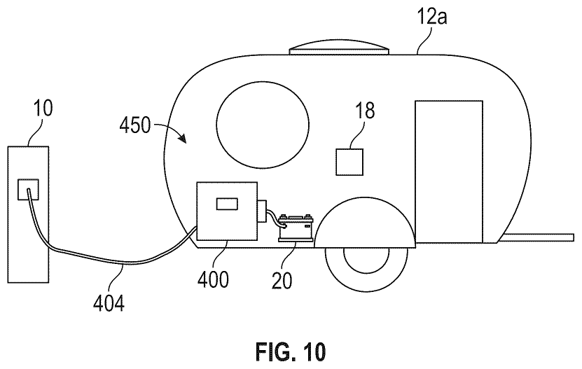

FIG. 10 depicts a recreational vehicle 12a which comprises an onboard controllable power supply unit 400. The recreational vehicle 12a can be the same as the recreational vehicle 12 except for the differences described below. The controllable power supply unit 400 can be a part of the recreational vehicle power system 450 of the recreational vehicle 12a. In some examples, the controllable power supply unit 400 can include a user interface display that is integrated with the interior design of the recreational vehicle 12a, e.g. a wall mounted panel, or the controllable power supply unit can be controlled from another device such as a smartphone, tablet, or personal computer. The controllable power supply unit 400 can include any combination of the functionality described above with respect to the controllable power supply unit 100. For example, the controllable power supply unit 400 can be configured to control the delivery of electrical power to the RV from the power pedestal according to criteria specified by a user including an energize time and a shutoff time. The controllable power supply unit 400 can comprise a power input connection 404 which is configured as an electrical cable interconnecting the power pedestal 10 and the controllable power supply unit 400. In some examples, the recreational vehicle power system 450 can comprise a battery 20 which can be electrically coupled to the controllable power supply unit 400. In some examples, the controllable power supply unit 400 can be constructed as a part of the recreational vehicle 12a during initial manufacturing of the recreational vehicle 12a. In some examples, the controllable power supply unit 400 can be integrated into the electronics of the recreational vehicle 12a.

In some examples, the user interface device 112 and/or a remote device allows a user to define the shutoff time and the energize time as times-of-day. Based on the user selected shutoff times and energize times the controller 120 can implement a repeating schedule in which the controller 120 commands the contactor 118 to an open state at the shutoff time and commands the contactor 118 to a closed state at the energize time. In some examples, the shutoff time and energize time define an OFF interval during which pedestal power is interrupted and the recreational vehicle is powered by the onboard battery and/or inverter. Where the shutoff time occurs earlier in a day than the energize time, the OFF interval is between the shutoff time and energize time on the same day; where the shutoff time occurs later in a day than the energize time, the OFF interval extends across midnight into the next day until the energize time is reached. In some examples, the shutoff time can correspond to a beginning of an electrical utility peak power pricing period and the energize time can correspond to an end of the peak power pricing period.

In some examples, the controller can receive data of a schedule including one or a plurality of user-selected shutoff times in which the controller is configured to interrupt power to the RV from the pedestal and one or a plurality of user-selected energize times in which the controller is configured to restore power to the RV from the pedestal. The shutoff time(s) and energize time(s) can define one or a plurality of time periods during which the RV is disconnected from the electrical power grid and operates on its internal battery or other power supply. In some examples, the plurality of time periods during which the RV is disconnected from the electrical power grid can correspond to periods of peak power pricing by the electrical power utility.

In some examples, an override can supersede the schedule, for example by energizing the contactor 118 when the user commands a manual override and/or when a battery state-of-charge (SOC) falls below a predetermined threshold. In some examples, the programmable controller 120 is configured to override a scheduled shutoff time based on battery SOC to prevent excessive battery depletion. For example, although the controller may be configured to open the contacts at a user-selected shutoff time and close the contacts at a user-selected energize time, the controller can also monitor the SOC of the battery 20 and, if the SOC falls below a first (lower) threshold, command the contactor 118 to move the plurality of contacts to the closed position (thereby reconnecting to pedestal power and allowing the battery to recharge), notwithstanding that the shutoff time has been reached. In some examples, the controller applies hysteresis so that the override does not cause frequent switching. For example, once the override is triggered, the controller can remain in the override (energized) condition until the SOC rises above a second (higher) threshold, at which point the controller resumes operation according to the scheduled shutoff/energize times (e.g., returning to the scheduled state if the current time is within a scheduled “off” interval).

In some examples, the recreational vehicle 12, 12a includes one or more electrical loads 18 (FIG. 1 and FIG. 10), for example, electrical appliances. Exemplary electrical appliances can include an air conditioning unit, a water heater, an electric flush toilet, a refrigerator, an electrical cooking appliance (e.g., an electric stove top range), and/or another electrical appliance typically associated with an RV. When the shutoff time is reached the programmable controller 120 opens the contacts of the contactor 118 to interrupt electrical power from the pedestal 10 such that one or more of those loads are disconnected from electric grid power until the energize time occurs and the controller closes the contacts to restore pedestal power. For example, during a scheduled “off” interval, pedestal power to an RV air conditioner can be cut so the air conditioner is prevented from running on peak-priced grid power, and at the energize time pedestal power is restored to the air conditioner. As another example, during the scheduled “off” interval pedestal power can be cut to a water heater electric heating element (or other selected appliance). During the “off” interval, any or all of the appliances on the RV (e.g., lower-draw loads such as interior LED lights and/or a water pump) can continue to be powered from the battery 20. At the energize time, the controller can restore pedestal power to the RV and high wattage appliances such as the air conditioning compressor, the water heater, etc., resume operating and the battery can recharge.

In some examples, the controller can also operate high wattage appliances during the off-peak period or “on” intervals prior to an upcoming peak power period to pre-cool or pre-heat the RV or consumables such as water. For example, the controller can be in communication with the RV thermostat and can run the air conditioning to achieve a selected temperature in the interior space before the electric grid power is disconnected. The temperature can be allowed to rise (or fall) in the RV during the “off” period. In some examples the temperature can be allowed to rise to a pre-selected high temperature or fall to a pre-selected low temperature. If the interior of the RV reaches the pre-selected high temperature or low temperature before the peak power period ends, the controller can be programmed to notify the user (e.g., through a user interface or a remote computing device such as a smartphone) and the user can elect to restore electrical grid power and run the heating/cooling system or wait until the end of the peak power period.

In some examples, the controllable power supply unit 100 can further provide power-conditioning functionality in addition to timed energizing and de-energizing. For example, the controllable power supply unit can include surge protection circuitry configured to mitigate or clamp transient overvoltage events from the power pedestal before such transients reach the RV loads, and the controllable power supply unit can further include a voltage-boosting circuit e.g., an autotransformer (or other transformer-based boost stage) configured to increase a low incoming pedestal voltage to a higher voltage delivered at the output to the RV.

In some examples, the programmable controller 120 of the controllable power supply 100 unit can receive, store, and execute user-entered scheduling instructions including a shutoff time, e.g. a time associated with a beginning of an electrical utility peak pricing period, and an energize time, e.g. a time associated with an end of the peak pricing period. During operation, the programmable controller 120 compares a current time value (e.g., generated by a real-time clock of the controller 120) to the stored shutoff time and energize time and, upon detecting that the shutoff time has been reached, outputs one or more control signals (e.g., a drive signal to a contactor coil or a switching driver) to cause the plurality of contacts of the contactor 118 to transition to an open position that interrupts delivery of shore power from a power pedestal to the recreational vehicle. Upon detecting that the energize time has been reached, the programmable controller 120 similarly outputs one or more control signals to cause the plurality of contacts of the contactor 118 to transition to a closed position that restores delivery of shore power to the recreational vehicle, thereby reducing or avoiding consumption of pedestal power during the peak pricing period. The controller can automatically restore electrical grid power from the pedestal power outside the peak pricing period.

### General Considerations

For purposes of this description, certain aspects, advantages, and novel features of the examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing quantities of components, forces, moments, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing examples from discussed prior art, the example numbers are not approximates unless the word “about” is recited. Furthermore, not all alternatives recited herein are equivalents.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A controllable power supply unit for a recreational vehicle, the controllable power supply unit comprising:
a power input connection configured to receive electrical power from a power pedestal providing power to a recreational vehicle;
a power outlet configured to electrically couple to a recreational vehicle power inlet and to supply power to the recreational vehicle;
a programmable controller; and
a contactor comprising a plurality of electrical contacts disposed between and in electrical contact with the power input connection and the power outlet, each of the plurality of electrical contacts comprising an open position that interrupts the power delivered to the recreational vehicle and a closed position that delivers power to the recreational vehicle,
wherein the programmable controller is configured to receive a user-selected shutoff time and a user-selected energize time and automatically command the contactor to move the plurality of contacts to the open position at the shutoff time to disconnect the recreational vehicle from the power pedestal and to move the plurality of contacts to the closed position at the energize time to reconnect the recreational vehicle to the power pedestal.

2. The controllable power supply unit of claim 1, further comprising one or more circuit breakers disposed between, and in electrical contact with, the power input connection and the power outlet.

3. The controllable power supply unit of claim 1, wherein the power input connection comprises a male plug configured to connect to a power pedestal and receive a 50-amp power supply.

4. The controllable power supply unit of claim 1, wherein the power outlet is a 50-amp receptacle configured to receive a 50-amp plug.

5. The controllable power supply unit of claim 1, further comprising a user interface configured to allow the user to input a preselected criteria into the programmable controller.

6. The controllable power supply unit of claim 1, further comprising a transformer electrically coupled to the power input connection and configured to step down power from the power input connection to power the programmable controller.

7. A recreational vehicle comprising the power supply unit of claim 1.

8. The recreational vehicle of claim 7, further comprising a battery in electrical contact with the controllable power supply unit.

9. A recreational vehicle power system, comprising:
a battery;
a controllable power supply unit electrically coupled to the battery, the controllable power supply unit comprising:
a power input cable configured to be electrically coupled to a power pedestal;
a power outlet configured to be electrically coupled to the battery;
a programmable controller; and
a plurality of electrical contacts disposed between and in electrical contact with the power input cable and the power outlet, each of the plurality of electrical contacts comprising an open position and a closed position;
wherein the programmable controller is configured to control a position of the plurality of electrical contacts based on a shutoff time and an energize time, wherein the plurality of electrical contacts are in the closed position at the energize time resulting in electrical power supplied to a recreational vehicle and the battery from the power pedestal and wherein the programmable controller is configured to position the plurality of electrical contacts in the open position at the shutoff time resulting in electrical power supplied to the recreational vehicle by the battery.

10. The recreational vehicle power system of claim 9, further comprising a user interface configured to allow the user to input the shutoff time and the energize time into the programmable controller.

11. The recreational vehicle power system of claim 9, wherein the programmable controller is configured to monitor a state of charge of the battery and to position the plurality of electrical contacts in the closed position when the state of charge falls below a predetermined setpoint.

12. The recreational vehicle power system of claim 9, further comprising one or more sensors configured to monitor electrical power supplied to the recreational vehicle power system.

13. A recreational vehicle comprising the recreational vehicle power system of claim 9.

14. A method of supplying electrical power to a recreational vehicle with a controllable power supply unit, the method comprising:
receiving instructions from a user via a user interface device, wherein the instructions comprise an energize time and a shutoff time, the shutoff time corresponding to a beginning of an electrical utility peak power pricing period and the energize time corresponding to an end of the peak power pricing period;
when the energize time is reached, moving a plurality of contacts of the controllable power supply unit to a closed position to supply electrical power from a pedestal to the recreational vehicle; and
when the shutoff time is reached, moving the plurality of contacts to an open position to interrupt electrical power from the pedestal to the recreational vehicle during the peak power pricing period.

15. The method of claim 14, further comprising monitoring electrical power supplied to a recreational vehicle power system using one or more sensors.

16. The method of claim 14, wherein receiving instructions from the user comprises receiving instructions input from a remote computing device.

17. The method of claim 14, wherein moving the plurality of contacts to an open position interrupts electrical power from the pedestal to a water heater onboard the recreational vehicle and moving the plurality of contacts to a closed position supplies electrical power from the pedestal to the water heater.

18. The method of claim 14, wherein moving the plurality of contacts to an open position interrupts electrical power from the pedestal to an electrical cooking appliance onboard the recreational vehicle and moving the plurality of contacts to a closed position supplies electrical power from the pedestal to the cooking appliance.

19. The method of claim 14, wherein moving the plurality of contacts to an open position interrupts electrical power from the pedestal to a refrigerator onboard the recreational vehicle and moving the plurality of contacts to a closed position supplies electrical power from the pedestal to the refrigerator.
